(19) United States
(12) Patent Application Publication
(10) Pub. No.: US 2013/0318138 A1
(43) Pub. Date: Nov. 28, 2013

(54) APPARATUS AND METHOD FOR PERFORMING DECIMAL DIVISION

(71) Applicant: Huan Pan, Chengdu (CN)

(72) Inventor: Huan Pan, Chengdu (CN)

(21) Appl. No.: 13/996,336

(22) PCT Filed: Sep. 30, 2011
(86) PCT No.: PCT/CN2011/001657

§ 371 Date: Aug. 12, 2013

(51) Int. Cl. G06F 17/10

(52) U.S. Cl. CPC G06F 17/10
USPC 708/208

(57) ABSTRACT

A method for performing decimal division comprises: scaling a unsigned divisor D to a range; calculating multiplies of the scaled unsigned divisor D; storing multiples of the scaled unsigned divisor in a register; predicting a next single-bit quotient using a remainder Rᵢ; and selecting a quotient using the reminder determining if a first number S₁ of a remainder of a scaled unsigned dividend B is equal to or greater than 6; calculating B−5D; and storing B−5D as Rᵢ in a remainder register.

### BRIEF BACKGROUND

1. Field of the Invention

The present invention relates to decimal division, and more specifically to hardware floating-point decimal division algorithm.

2. Description of Related Art

Most computers today support only binary fixed-point/floating-point processes in hardware. While suitable for many purposes, binary fixed-point/floating-point arithmetic cannot be directly used in financial, commercial, and user-centric applications or web services because the decimal data used in these applications cannot be represented exactly when using binary fixed-point/floating-point representation.

The problems of binary fixed-point/floating-point representation can be avoided by using base 10 (decimal) exponents and preserving those exponents whenever possible. Nowadays, decimal calculation has been widely used in financial, economic and scientific applications which require more precise results. Also in current commercial database, over 50% of data are stored in decimal format.

### DESCRIPTION OF THE FIGURES

Embodiments are illustrated by way of example and not limitation in the Figures of the accompanying drawings:

FIG. 1 shows a logic block diagram of a one decimal adder solution for performing decimal division according to one embodiment of the present invention;

FIG. 2 shows a logic block diagram of a two decimal adder solution for performing decimal division according to one embodiment of the present invention; and

FIG. 3 shows a flowchart of a method for performing decimal division according to one embodiment of the present invention.

FIG. 4 is a block diagram of a system according to an embodiment of the present invention.

FIG. 5 shows a scaling table for calculating a scaled divisor D and dividend B for the scaling for a range or “area” [1, 1.1).

FIG. 6 shows a scaling table for calculating a scaled divisor D and dividend B for the scaling for area [1, 10/9)

FIG. 7 shows a scaling table for calculating a scaled divisor D and dividend B for the scaling for area [1.1, 10/9)

FIG. 8 shows a scaling table for calculating a scaled divisor D and dividend B for the scaling for area [1, 9/8)

FIG. 9 shows a table for selecting a quotient for the area [1,1.1).

FIG. 10 shows a table for selecting a quotient for the area [1.1, 10/9).

FIG. 11 shows a table for selecting a quotient for the area [1,10/9).

FIG. 12 shows a table for selecting a quotient for the area [1, 9/8).

FIG. 13 shows a table for selecting a quotient for the area [1, 1.1).

FIG. 14 shows a table for selecting a quotient for the area [1.1, 10/9).

FIG. 15 shows a table for selecting a quotient for the area [1, 10/9).

FIG. 16 shows a table for selecting a quotient for the area [1, 9/8).

FIG. 17 shows an example based on a two-cycle decimal adder of the sequence of a decimal adder for calculating 2˜6D and B−5D.

FIG. 18 shows an example of the configuration of the remainder Rᵢ chosen unit of FIG. 1.

FIG. 19 shows an example of the configuration of the quotient select table of FIG. 1.

FIG. 20 shows an example of the operation of the sign regulator of FIG. 1.

FIG. 21 shows an embodiment of a timing sequence.

### DETAILED DESCRIPTION

The following description describes an apparatus and method for performing decimal division within or in association with a processor, computer system, or other processing apparatus. In the following description, numerous specific details such as processing logic, processor types, micro-architectural conditions, events, enablement mechanisms, and the like are set forth in order to provide a more thorough understanding of embodiments of the present invention. It will be appreciated, however, by one skilled in the art that the invention may be practiced without such specific details. Additionally, some well known structures, circuits, and the like have not been shown in detail to avoid unnecessarily obscuring embodiments of the present invention.

Although the below examples describe decimal division in the context of execution units and logic circuits, other embodiments of the present invention can be accomplished by way of a data or instructions stored on a machine-readable, tangible medium, which when performed by a machine cause the machine to perform functions consistent with at least one embodiment of the invention. In one embodiment, functions associated with embodiments of the present invention are embodied in machine-executable instructions. The instructions can be used to cause a general-purpose or special-purpose processor that is programmed with the instructions to perform the steps of the present invention. Embodiments of the present invention may be provided as a computer program product or software which may include a machine or computer-readable medium having stored thereon instructions which may be used to program a computer (or other electronic devices) to perform one or more operations according to embodiments of the present invention. Alternatively, steps of embodiments of the present invention might be performed by specific hardware components that contain fixed-function logic for performing the steps, or by any combination of programmed computer components and fixed-function hardware components.

Instructions used to program logic to perform embodiments of the invention can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

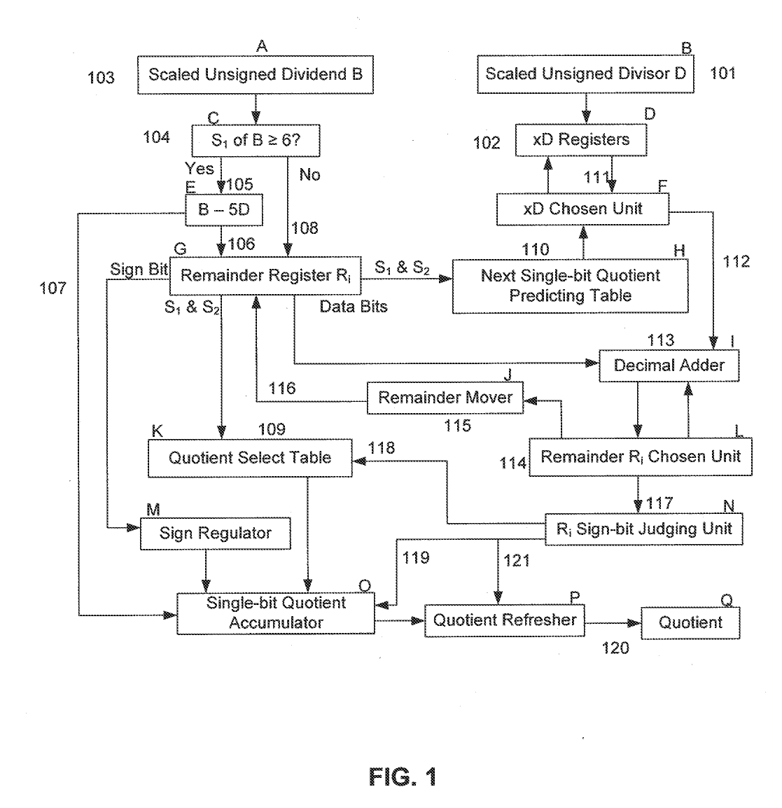

FIG. 1 shows a logic block diagram of a one decimal adder solution for performing decimal division according to one embodiment of the present invention. The logic may comprise the following blocks:

a block A, scaled unsigned dividend B, for calculating a scaled unsigned dividend B;

a block B, scaled unsigned divisor D, for calculating a scaled unsigned divisor D;

a block C, S₁ of B≧6?, for determining whether the first number S₁ of the scaled unsigned dividend B from block A is greater than or equal to 6;

a block D, xD registers, for storing multiples of scaled unsigned divisor D from block B;

a block E, B−5D, for calculating B−5D;

a block F, xD chosen unit, for choosing multiples of scaled unsigned divisor xD from block D;

a block G, remainder register Rᵢ, for storing the current dividend from blocks C,E and J;

a block H, next single-bit quotient predicting table, for predicting the next single-bit quotient according the input from block G;

a block I, decimal adder, for adding decimal numbers from block G and F;

a block J, remainder mover, for left shifting a remainder from block L for 1 bit and store it in block G;

a block K, quotient select table, for selecting the quotient according to input from block N;

a block L, remainder Rᵢ chosen unit, for choosing a remainder Rᵢ from the input from block I, and possibly interrupting the add calculation of block I;

a block M, sign regulator, for regulating signs;

a block N, Rᵢ sign-bit judging unit, for judging the sign-bit of Rᵢ from block L;

a block O, signal-bit quotient accumulator, for accumulating single-bit quotients from block K;

a block P, quotient refresher, for refreshing the final quotient for the division from block O; and

a block Q, quotient, for storing the quotient from block P.

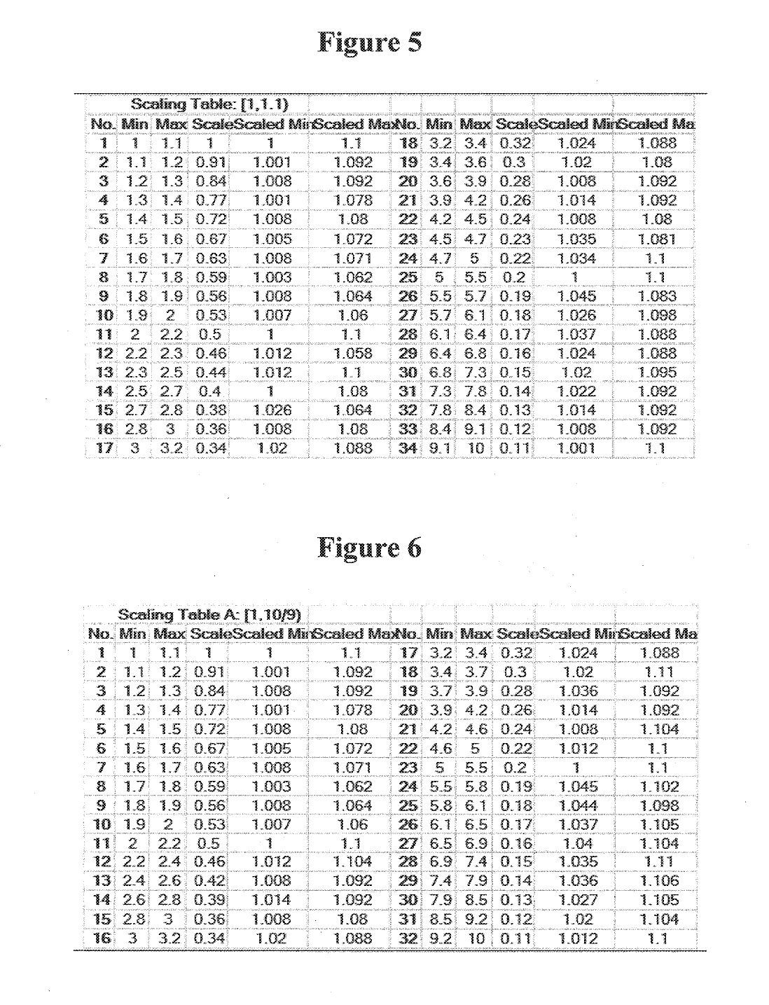

Blocks A and B may use scaling tables shown in FIGS. 5-9 to calculate a scaled divisor D and dividend B:

The scaling for range or “area” [1, 1.1) is shown in FIG. 5.

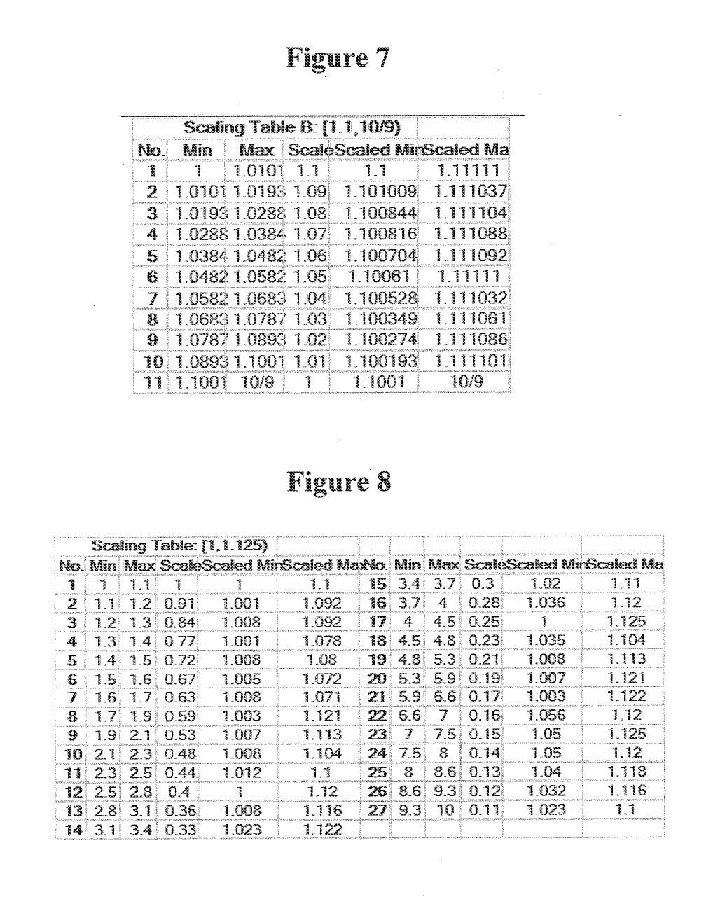

The scaling for areas [1, 10/9) and [1.1, 10/9) are shown in FIGS. 6 and 7 respectively.

The scaling for area [1, 9/8) is shown in FIG. 8.

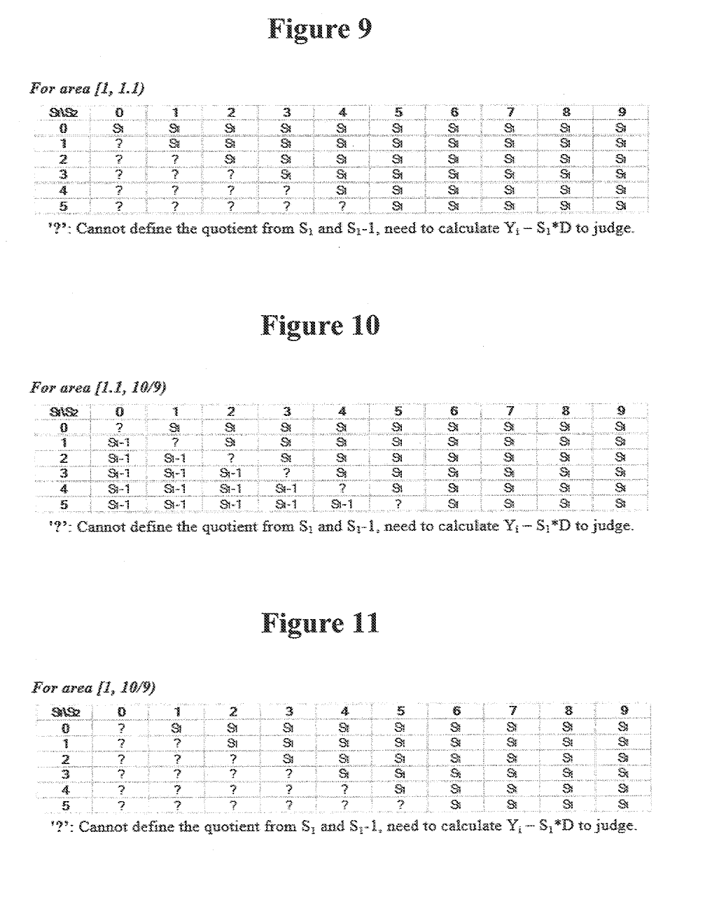

The block K may use the tables of FIGS. 9-12 to select a quotient. In these tables, S₁ and S₂ may represent the first and second numbers of the current dividend stored in the remainder register Rᵢ, and Yᵢ may represent the current dividend.

For the area [1,1.1), the table shown in FIG. 9 may be used.

For the area [1.1, 10/9), the table shown in FIG. 10 may be used.

For the area [1, 10/9), the table shown in FIG. 11 may be used.

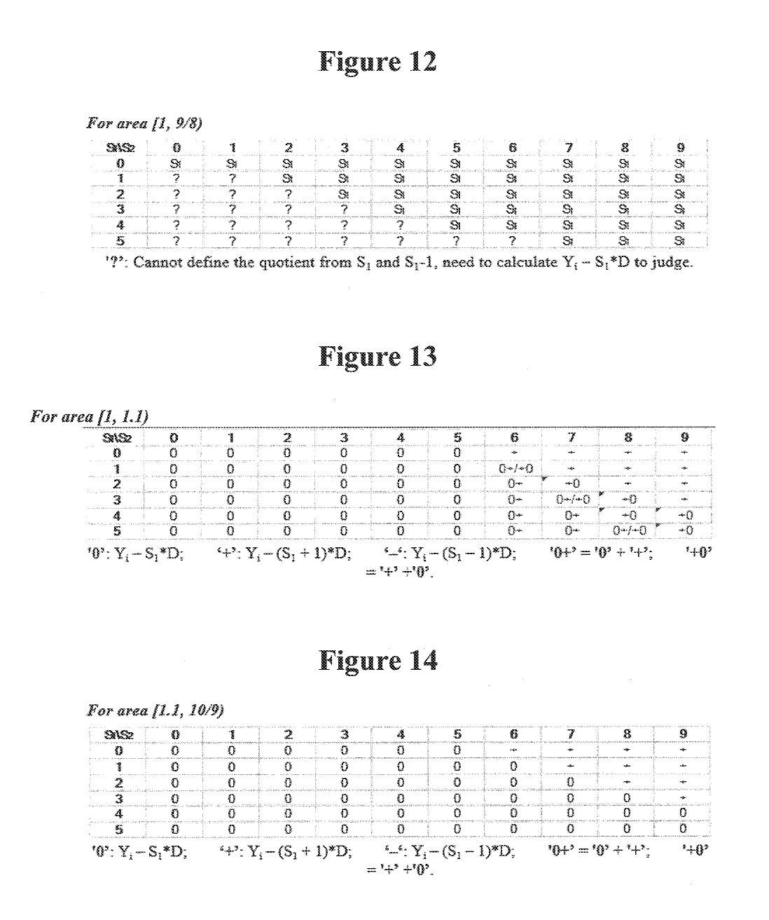

For the area [1, 9/8), the table shown in FIG. 12 may be used.

As can be seen from the tables of FIGS. 9-12, in more than 50% of cases, the quotient may be selected directly from the tables without further calculations.

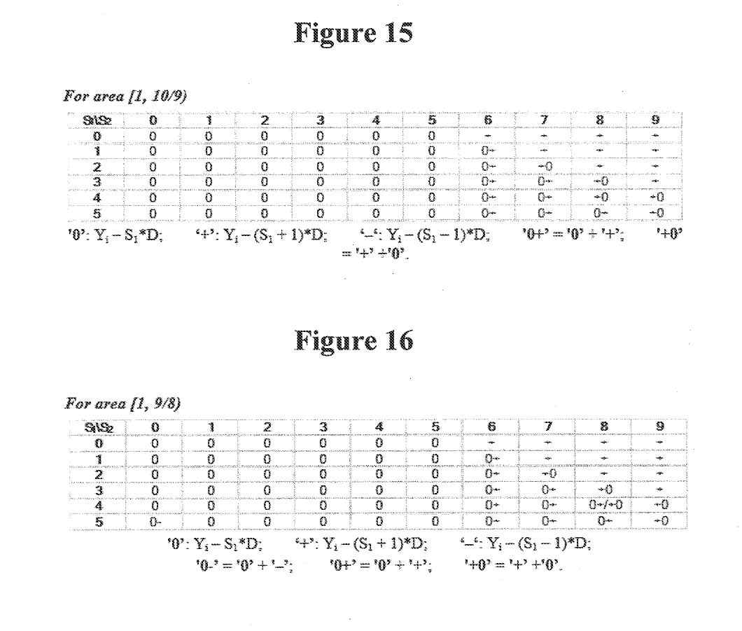

Block H may use the tables in FIGS. 13-16 to predict the next single-bit quotient which makes 10 times of the remainder belonging to [0,6). In these tables, S₁ and S₂ may represent the first and second numbers of the current dividend stored in the remainder register Rᵢ, and Yᵢ may represent the current dividend.

As can be seen, for S₁ and S₂ in the tables of FIGS. 9-12 with a “?”, i.e., for which the quotient could not be selected without further calculations, the quotient may be predicted by the tables of FIGS. 13-16 by calculating Yᵢ−S₁*D. One unique feature of the tables of FIGS. 13-16 is that the range of S₁ is 0˜5. Another unique feature of the tables of FIGS. 13-16 is that it may use calculations 0+ for some S₁/S₂ pairs, and use calculations +0 for other S₁/S₂ pairs, which the prior art does not have the sequence. A further unique feature of the tables of FIGS. 13-16 is that only one “add” operation, i.e., for operation “0”, is needed in most cases.

Referring to FIG. 1, the logic may be performed as follows:

At 101, an unsigned divisor D may be scaled according to the scaling tables of FIGS. 5-9 and multiples of the unsigned divisor D, 1˜6D, may be calculated at block B.

At 102, multiples of the scaled unsigned divisor 1˜6D may be stored in block D, xD Registers.

At 103, scaled unsigned dividend B may be calculated at block A.

At 104, it may be determined if the first number S₁ of the scaled unsigned dividend B is equal to or greater than 6.

If yes, B−5D may be calculated at the block E at 105 and sent to block g, the remainder register Rᵢ, at 106, and the number 5 may be sent to the single-bit quotient accumulator O at 107.

Otherwise, the scaled unsigned dividend B may be directly sent to the remainder register Rᵢ at 108.

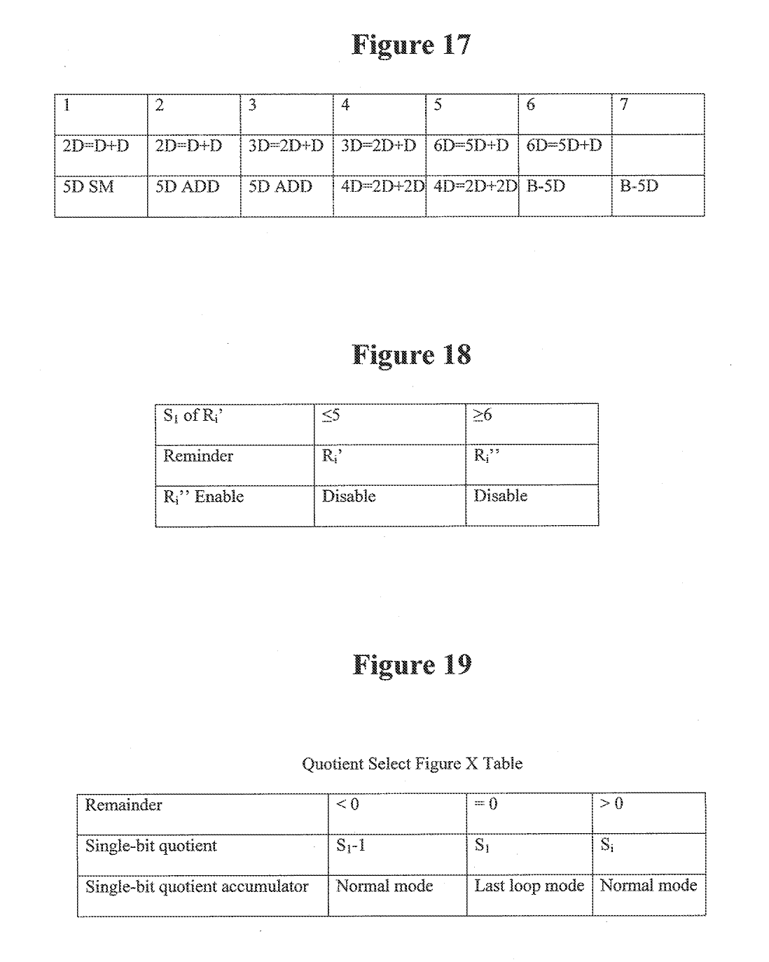

One example based on a two-cycle decimal adder of the sequence of a decimal adder for calculating 2˜6D and B−5D is shown in the table of FIG. 17.

At 109, the quotient select table K may determine the two possible single-bit quotients or the single-bit quotient directly with S₁ and S₂, the first 2 numbers of the current dividend in the remainder register Rᵢ, using the quotient select tables of FIGS. 9-12.

At 110, the next single-bit quotient predicting table H may receive S₁ and S₂ of the current dividend from the remainder register Rᵢ and determine xDs and their sequence needed for the next loop calculation.

The xD chosen unit F may then select xDs from xD registers D at 111 and send them to the decimal adder I at 112. These xDs are marked as x₁D and x₂D with sequence.

At 113, the decimal adder I may calculate Rᵢ′=Rᵢ−x₁D.

At 114, the remainder Rᵢ chosen unit L may determine S₁ of Rᵢ′=Rᵢ−x₁D to decide whether to finish the calculation of Rᵢ″=Rᵢ−x₂D. It may also determine the remainder of this cycle.

At 115, the remainder may be left shifted for 1 bit by the remainder mover J, and sent to the remainder register Rᵢ at 116. One example of the configuration of the remainder Rᵢ chosen unit L is shown in the table of FIG. 18.

At 117, the remainder may also be sent to the Rᵢ single-bit judging unit N to compare with 0.

At 118, based on an output from the Rᵢ single-bit judging unit N, the quotient select table K may determine the single-bit quotient from two possible single-bit quotients. One example of the configuration of the quotient select table K is shown in the table of FIG. 19.

If the remainder is equal to 0, the Rᵢ single-bit judging unit N may switch the single-bit quotient accumulator O to the last loop mode at 119, and inform the quotient refresher P to end this division operation at 121 after the quotient Q is refreshed at 120.

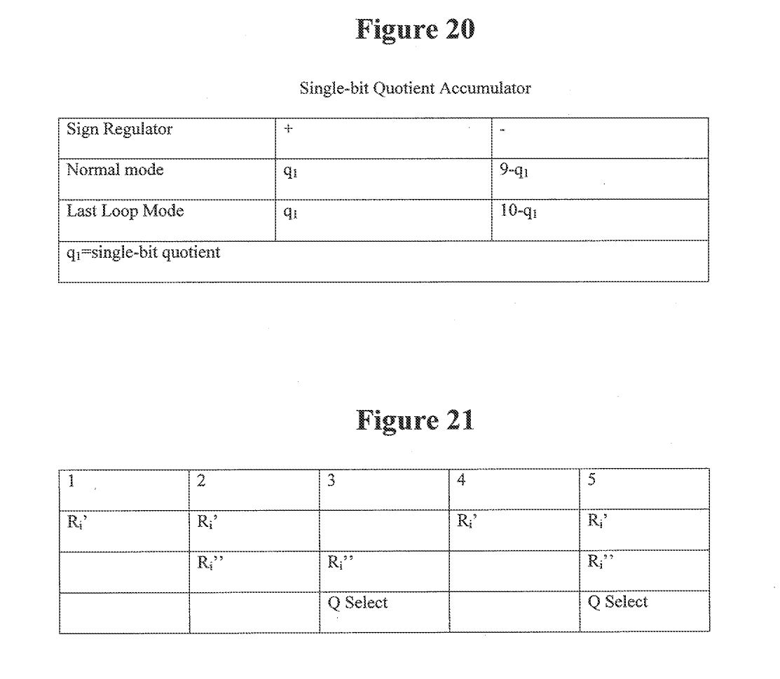

A sign regulator M may determine the way the single-bit quotient accumulator O works. As shown in the table of FIG. 20, the sign regulator M may be set to “+” status at beginning and it may change after the single-bit quotient accumulator O updates the quotient for this loop if the sign-bit of the remainder register Rᵢ is “−”. When the sign regulator M is set to “+” status, it may make the single-bit quotient from the quotient select table K to bypass the single-bit quotient accumulator O and directly be updated to the last bit of quotient by the quotient refresher P. When the sign regulator M is set to “−” status, the single-bit quotient accumulator O may calculate 9−single-bit quotient at the normal mode or 10−single-bit quotient at the last loop mode. The result may be updated as the last bit of the quotient.

In the performance of the logic, there are 2 different situations. One embodiment of a timing sequence of the logic is shown in the table of FIG. 21.

As shown, in cycles 1-3, and Rᵢ′ and Rᵢ″ may both need to be calculated and 3 cycles are consumed to get a one bit quotient. In cycles 4-5, only may need to be calculated and the calculation of Rᵢ″ may be interrupted by the remainder Rᵢ chosen unit, and only two cycles are consumed to get a one bit quotient. The timing sequence may control the logic in FIG. 1).

The logic 100 may be repeated until a required number of quotient digits are calculated or the remainder equals to 0.

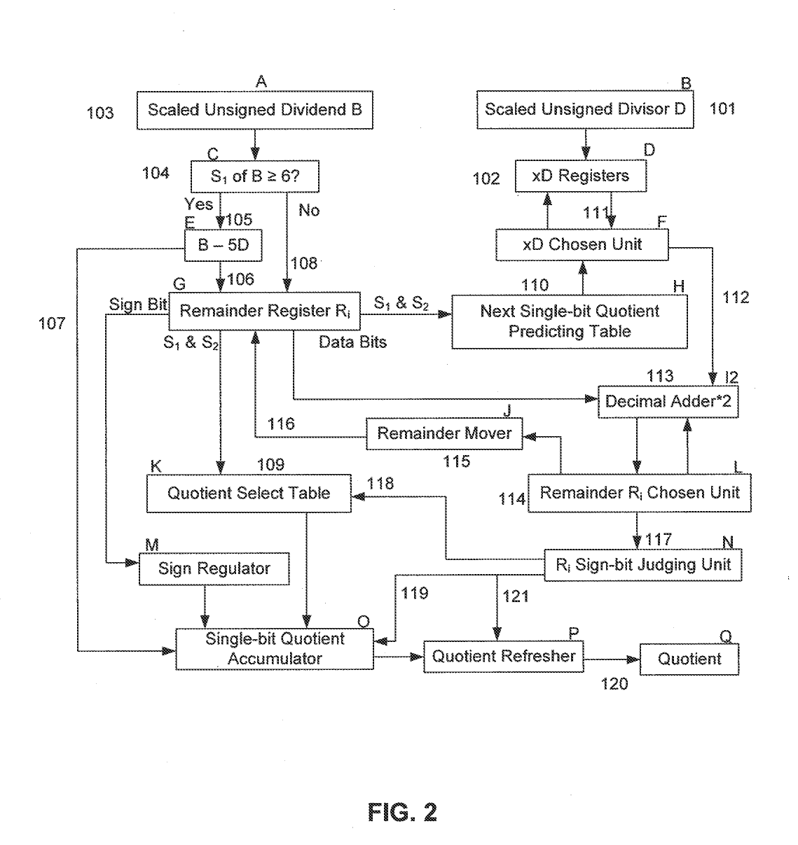

FIG. 2 shows a logic block diagram for a two decimal adder solution for performing decimal division according to one embodiment of the present invention. The most significant difference between the logic 200 shown in FIG. 2 and the logic 100 shown in FIG. 1 is that the logic 200 uses two decimal adders 12, instead of a decimal adder I. The logic 100 and the logic 200 may share the same flowchart.

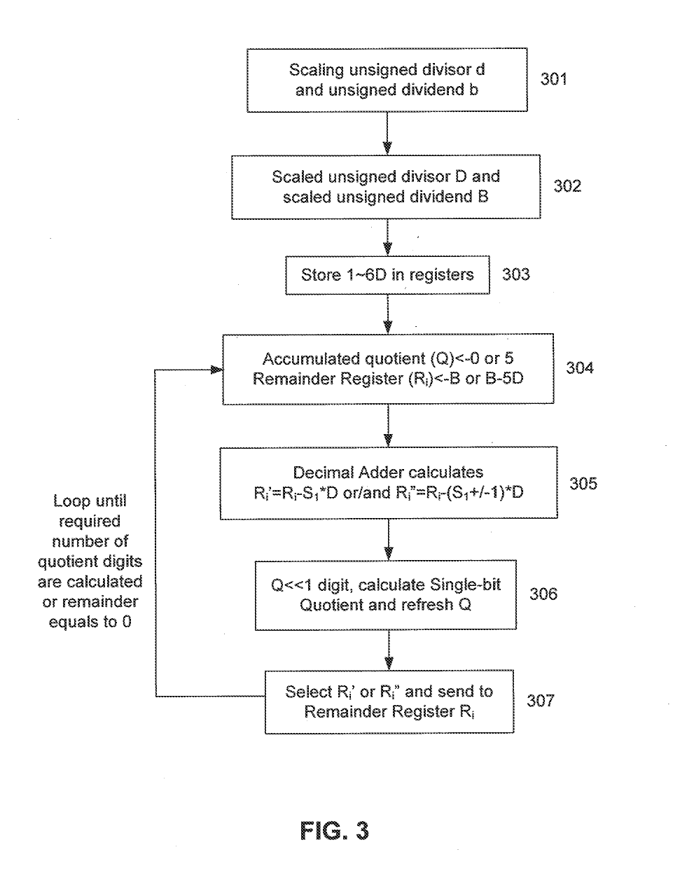

FIG. 3 shows a flowchart of a method for performing decimal division according to one embodiment of the present invention.

At 301, a unsigned divisor D may be scaled to the area [1.1, 10/9), [1, 10/9) or [1, 9/8), and a unsigned dividend may be scaled to the area [1, 10).

At 302, multiples of scaled unsigned divisor D may be calculated and sent to the xD registers.

At 303, the scaled unsigned dividend B or B−5D may be calculated and sent to the logic block G, the remainder register Rᵢ.

At 304, Rᵢ′ and Rᵢ″ may be calculated while the single-bit quotient for this loop may be updated and the quotient may be refreshed.

At 305, one of Rᵢ′ and Rᵢ″ may be selected and sent to the logic block G, the remainder register Rᵢ.

At 306, steps 304 and 305 may loop until a required number of quotient digits are calculated or the remainder equals to 0.

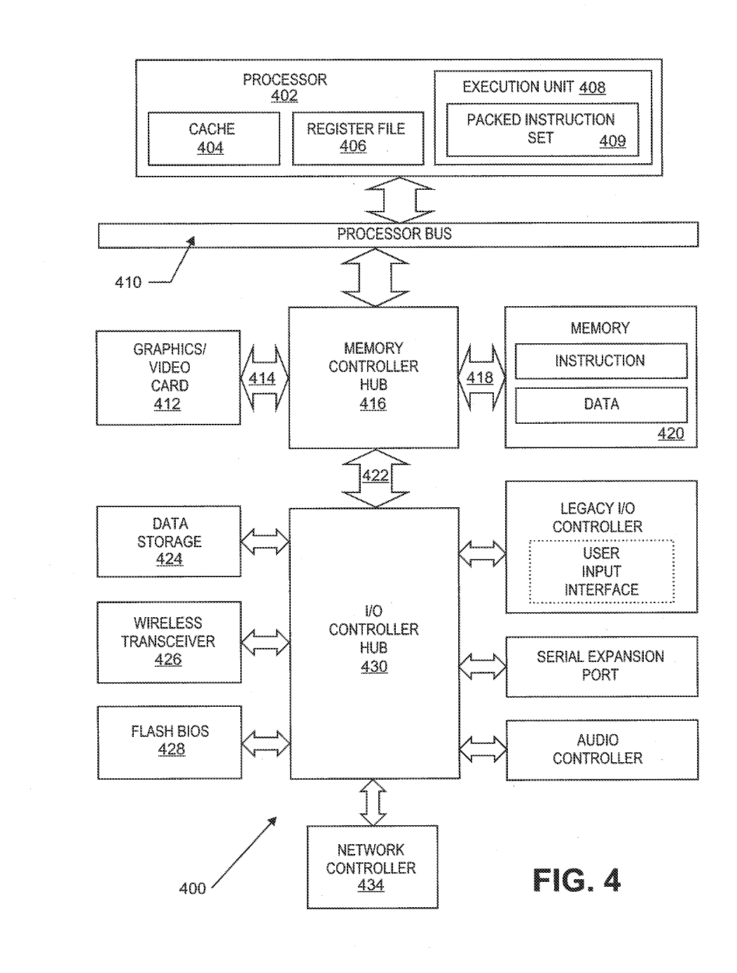

FIG. 4 is a block diagram of an exemplary computer system formed with a processor that includes execution units to execute instructions in accordance with one embodiment of the present invention. System 400 includes a component, such as a processor 402 to employ execution units including logic to perform algorithms for process data, in accordance with the present invention, such as in the embodiment described herein. System 400 is representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 400 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

FIG. 4 is a block diagram of a computer system 400 formed with a processor 402 that includes one or more execution units 408 to perform an algorithm to perform at least one instruction in accordance with one embodiment of the present invention. One embodiment may be described in the context of a single processor desktop or server system, but alternative embodiments can be included in a multiprocessor system. System 400 is an example of a ‘hub’ system architecture. The computer system 400 includes a processor 402 to process data signals. The processor 402 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 402 is coupled to a processor bus 410 that can transmit data signals between the processor 402 and other components in the system 400. The elements of system 400 perform their conventional functions that are well known to those familiar with the art.

In one embodiment, the processor 402 includes a Level 1 (L1) internal cache memory 404. Depending on the architecture, the processor 402 can have a single internal cache or multiple levels of internal cache. Alternatively, in another embodiment, the cache memory can reside external to the processor 402. Other embodiments can also include a combination of both internal and external caches depending on the particular implementation and needs. Register file 406 can store different types of data in various registers including integer registers, floating point registers, status registers, and instruction pointer register.

Execution unit 408, including logic to perform integer and floating point operations, also resides in the processor 402. The processor 402 also includes a microcode (ucode) ROM that stores microcode for certain macroinstructions. For one embodiment, execution unit 408 includes logic to handle a packed instruction set 409. By including the packed instruction set 409 in the instruction set of a general-purpose processor 402, along with associated circuitry to execute the instructions, the operations used by many multimedia applications may be performed using packed data in a general-purpose processor 402. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of an execution unit 408 can also be used in micro controllers, embedded processors, graphics devices, DSPs, and other types of logic circuits. System 400 includes a memory 420. Memory 420 can be a dynamic random access memory (DRAM) device, a static random access memory (SRAM) device, flash memory device, or other memory device. Memory 420 can store instructions and/or data represented by data signals that can be executed by the processor 402.

A system logic chip 416 is coupled to the processor bus 410 and memory 420. The system logic chip 416 in the illustrated embodiment is a memory controller hub (MCH). The processor 402 can communicate to the MCH 416 via a processor bus 410. The MCH 416 provides a high bandwidth memory path 418 to memory 420 for instruction and data storage and for storage of graphics commands, data and textures. The MCH 416 is to direct data signals between the processor 402, memory 420, and other components in the system 400 and to bridge the data signals between processor bus 410, memory 420, and system I/O 422. In some embodiments, the system logic chip 416 can provide a graphics port for coupling to a graphics controller 412. The MCH 416 is coupled to memory 420 through a memory interface 418. The graphics card 412 is coupled to the MCH 416 through an Accelerated Graphics Port (AGP) interconnect 414.

System 400 uses a proprietary hub interface bus 422 to couple the MCH 416 to the I/O controller hub (ICH) 430. The ICH 430 provides direct connections to some I/O devices via a local I/O bus. The local I/O bus is a high-speed I/O bus for connecting peripherals to the memory 420, chipset, and processor 402. Some examples are the audio controller, firmware hub (flash BIOS) 428, wireless transceiver 426, data storage 424, legacy I/O controller containing user input and keyboard interfaces, a serial expansion port such as Universal Serial Bus (USB), and a network controller 434. The data storage device 424 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

According to an embodiment of the present invention, a system for performing decimal division may contain a quotient select table K and a next single-bit quotient predicting table H which may predict the single-bit quotient and its remainder by judging the first two numbers of the current dividend stored in the remainder register Rᵢ. These two tables may be combined into one.

According to an embodiment, most areas of these tables just require one type of add operation to find the single-bit quotient and its remainder, and the current dividend which is the remainder left shifted for 1 bit, will belong to the area [0, 6), representing a range larger than or equal to 0 and smaller than 6. Also, the remaining areas which require two types of add operations may be sequenced to make it possible to stop the calculation when the first add operation finishes. The possibility is larger than 92.17%.

Embodiments of the invention may also indicate that these tables may be simplified as the current dividend which is stored in remainder register Rᵢ belongs to the area [0, 6), and so S₁=0, 1, 2, 3, 4 or 5 (refers to the quotient select table K and the next single-bit quotient predicting Table H). Embodiments of the invention also contain a component that may compare the remainder with 0, this may save computing recourses as well as avoiding the appearance of repeating 9s at the end.

Thus, techniques for performing decimal division according to at least one embodiment are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

1-30. (canceled)

31. A method for performing decimal division, comprising:
scaling an unsigned divisor D to a range;
calculating multiples of the scaled unsigned divisor D;
storing multiples of the scaled unsigned divisor in registers; and
predicting a single-bit of a quotient using a remainder Rᵢ from the division.

32. The method of claim 31, further comprising: determining if a first number S₁ of a remainder of a scaled unsigned dividend B is equal to or greater than 6.

33. The method of claim 31, further comprising: calculating B−5D and storing a result of the calculation as a remainder Rᵢ in a remainder register.

34. The method of claim 31, further comprising: selecting a quotient using Rᵢ.

35. The method of claim 31, wherein the range is selected from the group consisting of: [1.1, 10/9), [1, 10/9) and [1, 9/8).

36. The method of claim 31, wherein the range is [1, 1.1).

37. The method of claim 31, further comprising: scaling the unsigned dividend B to a range [1, 10).

38. The method of claim 31, further comprising: calculating a first remainder Rᵢ′ and a second remainder Rᵢ″.

39. The method of claim 38, further comprising: selecting one of Rᵢ′ and Rᵢ″ and storing the selected remainder in the remainder register Ri.

40. The method of claim 39, further comprising: repeating the calculating, selecting and storing of remainders Ri′ and Ri″ until a required number of quotient digits are calculated.

41. The method of claim 39, further comprising: repeating the calculating, selecting and storing of remainders Ri′ and Ri″ until the remainder equals to 0.

42. An apparatus for performing decimal division, comprising:
a device for scaling a unsigned divisor D to a range;
a multiplier for calculating multiples of the scaled unsigned divisor D;
a first register for storing multiples of the scaled unsigned divisor; and
a device for predicting a single-bit of a quotient using a remainder from the division.

43. The apparatus of claim 42, further comprising: a comparator for determining if a first number S₁ of a remainder of a scaled unsigned dividend B is equal to or greater than 6.

44. The apparatus of claim 42, further comprising: a remainder register for storing B−5D as a remainder

45. The apparatus of claim 42, further comprising: a device for selecting a quotient using Rᵢ.

46. The apparatus of claim 42, wherein the range is selected from the group consisting of: [1.1, 10/9), [1, 10/9) and [1, 9/8).

47. The apparatus of claim 42, wherein the range is [1, 1.1).

48. The apparatus of claim 42, further comprising: a device for scaling an unsigned dividend B to an range [1, 10).

49. The apparatus of claim 42, further comprising: a calculator for calculating a first remainder Rᵢ′ and a second remainder Rᵢ″.

50. The apparatus of claim 49, further comprising: a remainder register Rᵢ for storing one of Rᵢ′ and Rᵢ″.

51. The apparatus of claim 50, further comprising: a refresher for refreshing a quotient.

52. The apparatus of claim 50, further comprising: a device for determining whether a required number of quotient digits are calculated.

53. A system for performing decimal division which comprises:
a memory device;
a processor comprising
a device for scaling a unsigned divisor D to a range;
a multiplier for calculating multiples of the scaled unsigned divisor D;
a first register for storing multiples of the scaled unsigned divisor; and
a device for predicting a single-bit of a quotient using a remainder Rᵢ from the division.

54. The system of claim 53, further comprising: a device for determining if a first number S₁ of a remainder of a scaled unsigned dividend B is equal to or greater than 6.
